(19) United States
(12) Patent Application Publication
(10) Pub. No.: US 2017/0109131 A1
(43) Pub. Date: Apr. 20, 2017

(54) Earpiece 3D Sound Localization Using Mixed Sensor Array for Virtual Reality System and Method

(71) Applicant: BRAGI GmbH, Munchen (DE)

(72) Inventor: Peter Vincent Boesen, Munchen (DE)

(21) Appl. No.: 15/290,845

(22) Filed: Oct. 11, 2016

Related U.S. Application Data
(60) Provisional application No. 62/244,166, filed on Oct. 20, 2015.

(51) Int. Cl. G06F 3/16; G06F 3/0346; G06F 3/01; H04R 1/10

(52) U.S. Cl. CPC G06F 3/167; H04R 1/1016; H04R 1/1091; G06F 3/0346; G06F 3/012; H04R 2420/07

(57) ABSTRACT

A system and method for communicating with a virtual reality headset. The wireless earpieces are linked with the virtual reality headset. Playback of audio content is synchronized with visual content displayed by the virtual reality headset. The audio content is played in response to receiving the audio content from the virtual reality headset.

### PRIORITY STATEMENT

This application claims priority to U.S. Provisional Patent Application 62/244,166, filed on Oct. 20, 2015, and entitled Earpiece 3D Sound Localization Using Mixed Sensor Array for Virtual Reality System and Method, hereby incorporated by reference in its entirety.

### BACKGROUND

### I. Field of the Disclosure

The illustrative embodiments relate to virtual reality systems. More specifically, but not exclusively, the illustrative embodiments relate to interactions between wireless earpieces and virtual reality headsets.

### II. Description of the Art

The growth of virtual reality technology is growing nearly exponentially. This growth is fostered by the decreasing size of microprocessors, circuity boards, projectors, displays, chips, and other components. Virtual reality headsets are decreasing in size and increasing in functionality, but are still bulky and heavy. The additional mass of headphone units worn by a user may further unbalance motion of the user's head when utilizing a virtual reality system. Tracking the user's head motions relative to the virtual reality environment may also be difficult.

### SUMMARY OF THE DISCLOSURE

Therefore, it is a primary object, feature, or advantage of the present invention to improve over the state of the art.

It is a further object, feature, or advantage to minimize the mass effects of head mounted virtual reality systems.

It is a still further object, feature, or advantage to provide earpieces that are able to deliver three dimensional sound environments to the user.

It is another object, feature, or advantage to provide wireless earpieces which are capable of interfacing via a magnetic induction interface with a virtual reality headset.

It is a still further object, feature, or advantage to provide wireless earpieces that are able to transmit extremely accurate data as to the precise position of the user's head relative to the virtual reality environment using inertial sensors including sensors for accelerometer, magnetometry, and gyrometry.

It is yet another object, feature, or advantage to allow for the transmission of three dimensional sound from the virtual reality headset to wireless earpieces to allow for more accurate placement of the user in the virtual reality environment.

Another object, feature, or advantage is to allow for higher quality, more realistic user virtual reality experiences.

Yet another object, feature, or advantage is to allow for dual communication from each earpiece to the VR headset to assist with provide more accurate positioning of a user within a virtual reality environment as well as provide for more accurate 3D sound space to be transmitted to the user through the earpieces.

One or more of these and/or other objects, features, or advantages will be apparent from the specification that follows. No single embodiment need to meet or include each and every object, feature, or advantage as different embodiments may have different objects, features, or advantages.

According to one aspect, a system and method for communicating with a virtual reality headset is provided. The wireless earpieces are linked with the virtual reality headset. Playback of audio content is synchronized with visual content displayed by the virtual reality headset. The audio content is played in response to receiving the audio content from the virtual reality headset.

According to another aspect, wireless earpieces include a processor for executing a set of instructions and a memory for storing the set of instructions. The set of instructions are executed to link wireless earpieces with the virtual reality headset, synchronize playback of audio content with visual content displayed by the virtual reality headset, and play the audio content in response to receiving the audio content from the virtual reality headset.

According to another aspect, a virtual reality system is provided. The virtual reality system includes a virtual reality headset for displaying a virtual reality environment to a user. The virtual reality system also includes a wireless earpieces playing audio content associated with the virtual reality environment to the user, wherein the wireless earpieces are wireless coupled to the virtual reality headset such as through the use of magnetic induction.

### BRIEF DESCRIPTION OF THE DRAWINGS

Illustrated embodiments of the present invention are described in detail below with reference to the attached drawing figures, which are incorporated by reference herein, and where:

FIG. 1 is a pictorial representation of a virtual reality system in accordance with an illustrative embodiment;

FIG. 2 is a block diagram of wireless earpieces and virtual reality headset in accordance with an illustrative embodiment;

FIG. 3 is a flowchart of a process for communicating with a virtual reality headset in accordance with an illustrative embodiment;

FIG. 4 is a block diagram showing examples of different types of sensors.

### DETAILED DESCRIPTION OF THE DISCLOSURE

The illustrative embodiments provide a system and method for communications between a virtual reality headset and wireless earpieces. In one embodiment, the virtual reality headset may be coupled to the wireless earpieces utilizing magnetic induction such as near field magnetic induction (NFMI).

The illustrative embodiments may be utilized for entertainment, scientific, educational, or commercial applications. Virtual reality headsets, such as those produced by Google, HTC, Samsung, Oculus, Sony, Microsoft, and so forth, may present any number of two-dimensional or three-dimensional visualizations to the user. The illustrative embodiments minimize the existing mass problems with bulky over here headphone or audio systems. As a result, the characteristics of angular momentum associated with the user's head are not increased significantly decreasing the effects of torque and neck arid head strain that may be associated with such virtual reality systems.

The wireless earpieces may include any number of sensors that may communicate with the sensors, systems and components of the virtual reality headset to further enhance the user's experience. In one embodiment, the sensors of the wireless earpieces may include inertial sensors (such as accelerometers, gyroscopes, magnetometers), optical sensors, pulse oximeters, GPS chips, thermometers or temperature sensors, and so forth. The data acquired by the sensors may be utilized to determine the user's condition, characteristics, position, location, or so forth. As a result, the data may be utilized to enhance the user's experience within the virtual reality environment. In addition, the sensors provide data that enhances sensor measurements of the virtual reality headset. The precise determination of the user's location and position may also be utilized to provide more accurate three-dimensional spatial sound imaging for the user. For example, the sound being reproduced as part of a virtual reality experience may be coordinated with location, position, or movement of the user. Thus, by moving one's head the virtual reality experience may change.

In addition, the sensors may be utilized to sense any number of biometric readings or information, such as heart rate, respiratory rate, blood, or skin physiology, or other biometric data. This information may be utilized to determine whether the user is safe in the virtual reality environment, enjoying a game, or if the user is stressed or fatigued. Besides being, integrated with the virtual reality headset, the wireless earpieces may be utilized to make and receive communications (e.g., telephone calls, transcribed text messages, audio/tactile alerts, etc.), play music, filter or block sound, amplify sounds, or so forth.

The wireless earpieces may be utilized for daily activities, such as exercising, phone calls, travel, and so forth. The wireless earpieces may then also serve a dual-purpose by integrating as an audio portion of a virtual reality system. As a result, more expensive audio components are not required reducing the cost and weight of the virtual reality system. The user may be relieved of significant weight and strain by utilizing the reduced footprint of the wireless earpieces.

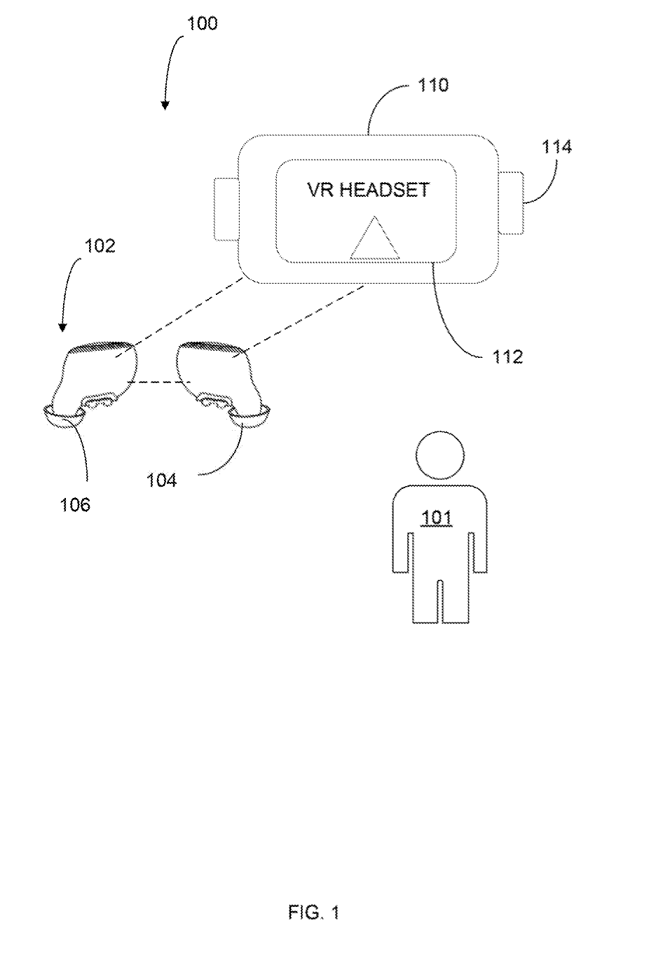

FIG. 1 is a pictorial representation of a virtual reality system 100 in accordance with an illustrative embodiment. The virtual reality system 100 may include any number of devices, components, systems. As shown in FIG. 1, the virtual reality system 100 is used by a user or participant 101. The virtual reality system 100 includes a virtual reality headset 110 and wireless earpieces 102 including a right earpiece 104 and a left earpiece 106. The virtual reality headset 110 may also be wireless and may include a visor 112, and a strap 114 or may be of other physical configuration. The virtual reality headset 110 may be in operative communication with one or both earpieces 102 such as through magnetic induction such as a near field magnetic induction (NFMI) transceiver, or other transceiver.

The wireless earpieces 102 may be referred to as a pair or set (wireless earpieces 102) or singularly (right earpiece 104, left earpiece 106). The description may also refer to components and functionality of each of the wireless earpieces 102 collectively or individually. In one embodiment, the wireless earpieces 102 include a left earpiece and a right earpiece configured to fit into ears of a user 101. The wireless earpieces 102 are shown separately from their positioning within the ears of the user 101 for purposes of simplicity.

The wireless earpieces 102 are configured to play audio associated with visual content presented by the virtual reality headset 110. The wireless earpieces 102 may be configured to play music or audio, receive and make phone calls or other communications, determine ambient environmental readings (e.g., temperature, altitude, location, speed, heading, etc.), read user biometrics and actions (e.g., heart rate, motion, sleep, blood oxygenation, calories burned, etc.) or otherwise sense information regarding the user and/or the environment.

The wireless earpieces 102 may include interchangeable parts that may be adapted to fit the needs of the user 101. For example, sleeves of the wireless earpieces 102 that fit into the ear of the user 101 may be interchangeable to find a suitable shape and configuration. The wireless earpieces 102 may include a number of sensors and input devices including, but not limited to, pulse oximeters, microphones, pulse rate monitors, accelerometers, gyroscopes, light sensors, global positioning sensors, and so forth. Sensors of the virtual reality headset 110 may also be configured to wirelessly communicate with the wireless earpieces 102.

The virtual reality headset 110 replicates or displays an environment simulating physical presence in places in the real world or imagined worlds and lets the user 101 interact in that environment. Virtual reality may also be referred to as immersive multimedia and may be utilized to create sensory experiences which may include sight, hearing, touch, smell, and taste. The virtual reality headset 110 may be powered by a power plug, battery, or other connection (e.g., USB connection to a computing or gaming device). The virtual reality headset 110 may also communicate (send and receive) data utilizing a wired or wireless connection to any number of computing, communications, or entertainment devices.

The visor 112 may be utilized to display visual and graphical information to the user 101. The visor 112 may include one or more displays (e.g., liquid crystal displays, light emitting diode (LED) displays, organic LED, etc.) or projectors (direct, indirect, or refractive) for displaying information to the eyes of the user 101. Although not shown, the virtual reality headset 110 may also include touch screens, smell interfaces, or tasting interfaces for enhancing the experience of the user 101. The size and shape of the virtual reality headset 110, visor 112, and the strap 114 may vary by make, model, manufacturer as well as user configuration of the virtual reality headset 110, such as those produced by Google, HTC, Sony, Oculus, Epson, Samsung, LG, Microsoft, Durovis, Valve, Avegant, and others.

The strap 114 extends between sides of the visor 112 and is configured to secure the virtual reality headset 110 to the head of the user 101. The strap 114 may be fanned of any number of materials, such as cotton, polyester, nylon, rubber, plastic, or so forth. The strap 114 may include buckles, loops, or other adjustment mechanisms for fitting the virtual reality headset 110 to the head of the user 101. Some virtual reality headsets are much more helmet-like or include various structural components (e.g., straps, arms, extensions, etc.) for securing the virtual reality headset 110 to the head of the user 101 during both regular and vigorous usage.

The wireless earpieces 118 communicate with the leadset 110. Magnetic induction such as near field magnetic induction (NFMI) may be used for communication between the wireless earpieces 118 and the headset 110. Alternatively, the wireless earpieces 102 may communicate utilizing any number of wireless connections, standards, or protocols (e.g., near field communications, Bluetooth, Wi-Fi, ANT+, etc.). The virtual reality headset 110 may locally or remotely implement and utilize any number of operating systems, kernels, instructions, or applications that may make use of the sensor data measured by the wireless earpieces 102. For example, the virtual reality headset 110 may utilize any number of Android, iOS, Windows, open platform, or other systems. Similarly, the virtual reality headset 110 may include a number of applications that utilize the biometric data from the wireless earpieces 102 to display applicable information and data. For example, the biometric information (including, high, low, average, or other values) may be processed by the wireless earpieces 102 or the virtual reality headset 110 to display heart rate, blood oxygenation, altitude, speed, distance traveled, calories burned, or other applicable information.

In one embodiment, the wireless device 106 may include any number of sensors (e.g., similar to those described with regard to the wireless earpieces 104) that may be utilized to augment the sensor readings of the wireless earpieces 104. For example, a microphone of the wireless device 106 may determine an amount and type of ambient noise. The noise may be analyzed and utilized to filter the sensor readings made by the wireless earpieces 104 to maximize the accuracy and relevance of the sensor measurements of the wireless earpieces 104. Filtering, tuning, and adaptation for the sensor measurements may be made for signal noise, electronic noise, or acoustic noise, all of which are applicable in the communication system 100. Sensor measurements made by either the wireless earpieces 104, wireless device 106, or sensor devices of the user 102 may be communicated with one another in the communication system 100. The wireless device 106 is representative of any number of personal computing, communications, exercise, medical, or entertainment devices that may communicate with the wireless earpieces 104.

With respect to the wireless earpieces 104, sensor measurements may refer to measurements made by one or both of the wireless earpieces 104. For example, the wireless earpieces 104 may determine that the sensor signal for the pulse oximeter of the right wireless earpiece is very noisy and as a result, may utilize the sensor signal from the pulse oximeter of the left wireless earpiece as the primary measurement. The wireless earpieces 104 may also switch back and forth between pulse oximeters of the left and right side in response to varying noise for both of the wireless earpieces. As a result, clearest sensor signal may be utilized at any given time. In one embodiment, the wireless earpieces 104 may switch sensor measurements in response to the sensor measurements exceeding or dropping below a specified threshold. Alternatively, some sensors may be present in only one of the earpieces, the left or the right.

The user 102 may also be wearing or carrying any number of sensor-enabled devices, such as heart rate monitors, pacemakers, smart glasses, smart watches or bracelets (e.g., Apple watch, Fitbit, etc.), or other sensory devices that may be worn, attached to, or integrated, with the user 102. The data and information from the external sensor devices may be communicated to the wireless earpieces 104. In another embodiment, the data and information from the external sensor devices may be utilized to perform additional processing of the information sent from the wireless earpieces 104 to the wireless device 106.

The sensors of the wireless earpieces be positioned at enantiomeric locations. For example, a number of colored light emitting diodes may be positioned to provide variable data and information, such as heart rate, respiratory rate, and so forth. The data gathered by the LED arrays may be sampled and used alone or in aggregate with other sensors. As a result, sensor readings may be enhanced and strengthened with additional data.

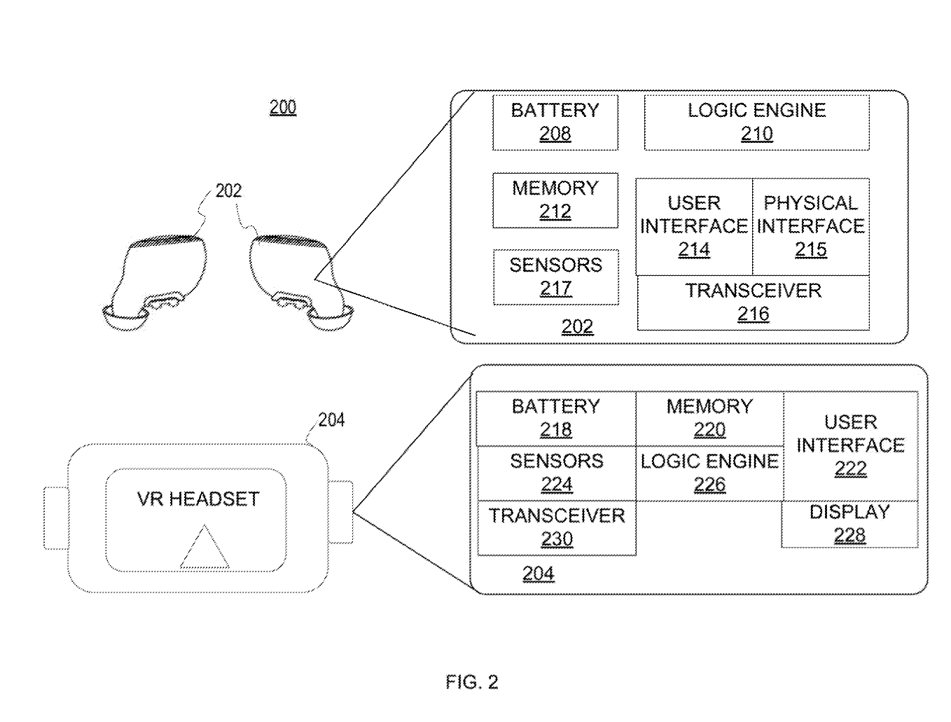

FIG. 2 is a block diagram of a virtual reality system 200 in accordance with an illustrative embodiment. In one embodiment, the virtual reality system 200 may include wireless earpieces 202 (described collectively rather than individually) and virtual reality headset 204. In one embodiment, the wireless earpieces 202 may enhance communications and functionality of the virtual reality system 200. For example, the wireless earpieces 202 may provide high quality audio that complements the virtual environments provided by the virtual reality headset 204.

As shown, the wireless earpieces 202 may be physically or wirelessly linked to the virtual reality headset 204. User input and commands may be received from either the wireless earpieces 202 or the virtual reality headset 204 for implementation on either of the devices of the virtual reality system 200 (or other externally connected devices). As previously noted, the wireless earpieces 102 may be referred to or described herein as a pair (wireless earpieces) or singularly (wireless earpiece). The description may also refer to components and functionality of each of the wireless earpieces 202 collectively or individually.

The wireless earpieces 202 play the audio corresponding to the virtual reality content displayed by the virtual reality headset 204. In addition, the wireless earpieces 202 may provide additional biometric and user data that may be further utilized by the virtual reality headset 204 or connected computing, entertainment, or communications

In some embodiments, the virtual reality headset 204 may act as a logging tool for receiving information, data, or measurements made by the wireless earpieces 202. For example, the virtual reality headset 204 may be worn by the user to download data from the wireless earpieces in real-time. As a result, the virtual reality headset 204 may be utilized to store, display, and synchronize data to the wireless earpieces 202. For example, the virtual reality headset 204 may display pulse, oxygenation, distance, calories burned, and so forth as measured by the wireless earpieces 202. The wireless earpieces 202 and the virtual reality headset 204 may have any number of electrical configurations, shapes, and colors and may include various circuitry, connections, and other components.

In one embodiment, the wireless earpieces 202 may include a battery 208, a logic engine 210, a memory 212, user interface 214, physical interface 215, a transceiver 216, and sensors 212. The virtual reality headset 204 may have a battery 218, a memory 220, an interface 222, and sensor or sensors 224. The battery 208 is a power storage device configured to power the wireless earpieces 202. Likewise, the battery 218 is a power storage device configured to power the virtual reality headset 204. In other embodiments, the batteries 208 and 218 may represent a fuel cell, thermal electric generator, piezo electric charger, solar charger, ultra-capacitor, or other existing or developing power storage or power generation technologies.

The logic engine 210 is the logic that controls the operation and functionality of the wireless earpieces 202. The logic engine 210 may include circuitry, chips, and other digital logic. The logic engine 210 may also include programs, scripts, and instructions that may be implemented to operate the logic engine 210. The logic engine 210 may represent hardware, software, firmware, or any combination thereof. In one embodiment, the logic engine 210 may include one or more processors. The logic engine 210 may also represent an application specific integrated circuit (ASIC) or field programmable gate array (FPGA). The logic engine 210 may be utilize information from the sensors 212 to determine the biometric information, data, and readings of the user. The logic engine 202 may utilize this information and other criteria to inform the user of the biometrics (e.g., audibly, through an application of a connected device, tactilely, etc.).

The logic engine 210 may also process user input to determine commands implemented by the wireless earpieces 202 or sent to the wireless earpieces 204 through the transceiver 216. The user input may be determined by the sensors 217 to determine specific actions to be taken. In one embodiment, the logic engine 210 may implement a macro allowing the user to associate user input as sensed by the sensors 217 with commands.

In one embodiment, a processor included in the logic engine 210 is circuitry or logic enabled to control execution of a set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications elements of the smart case 202.

The memory 212 is a hardware element, device, or recording media configured to store data for subsequent retrieval or access at a later time. The memory 212 may be static or dynamic memory. The memory 212 may include a hard disk, random access memory, cache, removable media drive, mass storage, or configuration suitable as storage for data, instructions, and information. In one embodiment, the memory 212 and the logic engine 210 may be integrated. The memory may use any type of volatile or non-volatile storage techniques and mediums. The memory 212 may store information related to the status of a user, wireless earpieces 202, virtual reality headset 204, and other peripherals, such as a wireless device, smart case for the wireless earpieces 202, smart watch, and so forth. In one embodiment, the memory 212 may display instructions or programs for controlling the user interface 714 including one or more LEDs or other light emitting components, speakers, tactile generators (e.g., vibrator), and so forth. The memory 212 may also store the user input, information associated with each command.

The transceiver 216 is a component comprising both a transmitter and receiver which may be combined and share common circuitry on a single housing. The transceiver 216 may communicate utilizing Bluetooth, ZigBee, Ant+, near field communications, wireless USB, infrared, mobile body area networks, ultra-wideband communications, cellular (e.g., 3G, 4G, 5G, PCS, GSM, etc.) or other suitable radio frequency standards, networks, protocols, or communications. The transceiver 216 may also be a hybrid transceiver that supports a number of different communications. For example, the transceiver 216 may communicate with the virtual reality headset 204 or other systems utilizing wired interfaces (e.g., wires, traces, etc.), NFC or Bluetooth communications. It is to be understood that more than one transceiver may be present in the earpieces. For example, each earpiece may include a near field magnetic induction (NFMI) transceiver and one or both earpieces may include a radio transceiver such as a Bluetooth or BLE transceiver. The VR headset may similarly include more than one transceiver. For example, the VR headset may include a near field magnetic induction (NFMI) transceiver as well as a radio transceiver such as a Bluetooth or BLE transceiver. Thus, for example the VR headset may communicate with one or both earpieces over one communications channel and the VR headset may also communicate wirelessly with one or more other devices such as a mobile device, gaming system, or other computing device.

The components of the wireless earpieces 202 (or the virtual reality system 200) may be electrically connected utilizing any number of wires, contact points, leads, busses, less interfaces, or so forth. In addition, the wireless earpieces 202 may include any number of computing and communications components, devices or elements which may include busses, motherboards, circuits, chips, sensors, ports, interfaces, cards, converters, adapters, connections, transceivers, antennas, and other similar components. The physical interface 215 is a hardware interface of the wireless earpieces 202 which may be present for connecting and communicating with other electrical components.

Where present, the physical interface 215 may include any number of pins, arms, or connectors for electrically interfacing with the contacts or other interface components of external devices or other charging or synchronization devices. For example, the physical interface 215 may be a micro USB port. In another embodiment, the physical interface 215 may include a wireless inductor for charging the wireless earpieces 202 without a physical connection to a charging device

The user interface 214 is a hardware interface for receiving commands, instructions, or input through the touch (haptics) of the user, voice commands, or predefined motions. The user interface 214 may be utilized to control the other functions of the wireless earpieces 202. The user interface 214 may include the LED array, one or more touch sensitive buttons or portions, a miniature screen or display, or other input/output components. The user interface 214 may be controlled by the user or based on commands received from the virtual reality headset 204 or a linked wireless device.

In one embodiment, the user may provide feedback by tapping the user interface 214 once, twice, three times, or any number of times. Similarly, a swiping motion may be utilized across the user interface 214 (e.g., the exterior surface of the wireless earpieces 202) to implement a predefined action. Swiping motions in any number of directions may be associated with specific activities, such as play music, pause, fast forward, rewind, activate a digital assistant (e.g., Siri, Cortana, smart assistant, etc.). The swiping motions may also be utilized to control actions and functionality of the virtual reality headset 204 or other external devices (e.g., smart television, camera array, smart watch, etc.). The user may also provide user input by moving her head in a particular direction or motion or based on the user's position or location. For example, the user may utilize voice commands, head gestures, or touch commands to change the content displayed by the virtual reality headset 204.

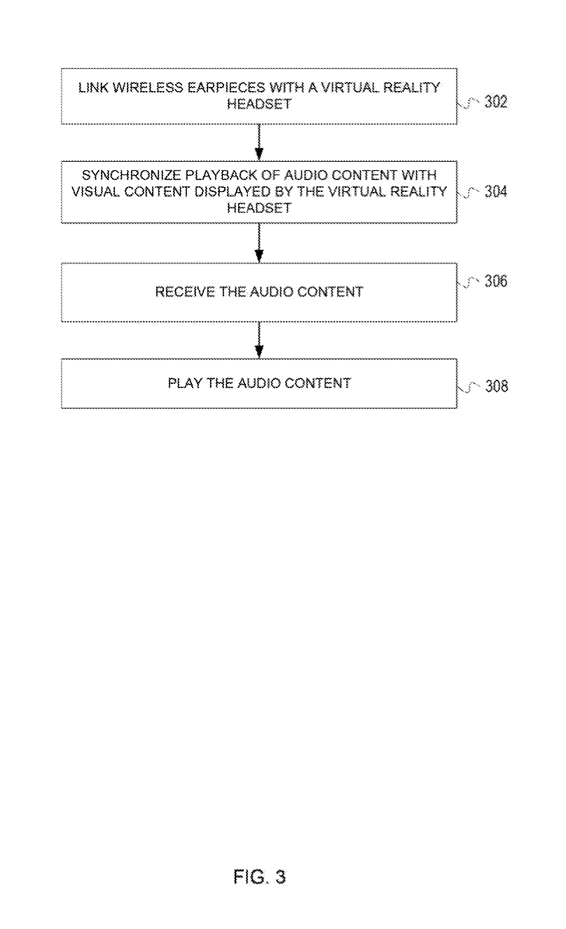

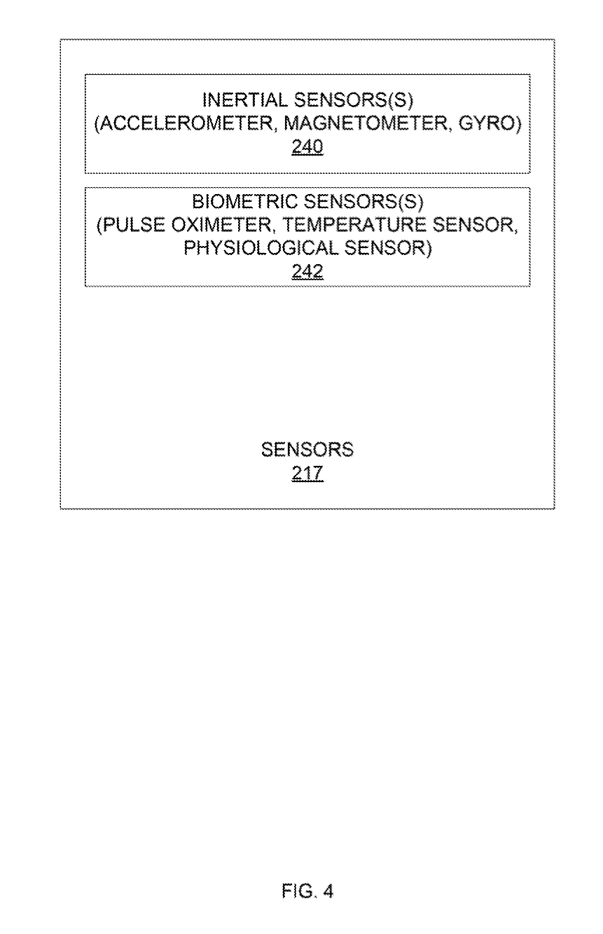

The sensors 217 may include pulse oximeters, accelerometers, gyroscopes, magnetometers, inertial sensors, photo detectors, miniature cameras, and other similar instruments for detecting location, orientation, motion, and so forth. FIG. 4 illustrates examples of sensors 217 including inertial sensors 240 which may include accelerometers, magnetometers, or gyroscope (or gyro). For example a single inertial sensor may be a 9-axis which includes a 3-axis gyroscope, 3-axis accelerometer, and a 3-axis magnetometer. In addition, the sensors may include biometric sensors 242 such as a pulse oximeter, temperature sensor, or other types of physiological sensor. Returning to FIG. 3, the sensors 217 may also be utilized to gather optical images, data, and measurements and determine an acoustic noise level, electronic noise in the environment, ambient conditions, and so forth. The sensors 217 may provide measurements or data that may be utilized to filter or select images for display by the virtual reality headset 204. For example, motion or sound detected on the left side of the user may be utilized to command the smart glasses to display camera images from the left side of the user. Motion or sound may be utilized, however, any number of triggers may be utilized to send commands to the virtual reality headset 204.

The virtual reality headset 204 may include components similar in structure and functionality to those shown for the wireless earpieces 202 including a battery 218, a memory 220, a user interface 222, sensors 224, a logic engine 226, a display 228, and transceiver 230. The virtual reality headset 204 may include the logic engine 226 for executing and implementing the processes and functions as are herein described. The battery 218 of the virtual reality headset 204 may be integrated into the frames of the virtual reality headset 204. All or a portion of the logic engine 226, sensors, user interface 222, sensors 224, display, and transceiver 230 may be integrated in the frame and/or lenses of the virtual reality headset 204.

The user interface 222 of the virtual reality headset 204 may include a touch interface or display for indicating the status of the virtual reality headset 204. For example, an external LED light may indicate the battery status of the virtual reality headset 204 as well as the connected wireless earpieces 202, connection status (e.g., linked to the wireless earpieces 202, wireless device, etc.). download/synchronization status (e.g., synchronizing., complete, last synchronization, etc.), or other similar information. The display 228 may be integrated into the lenses of the virtual reality headset 204 or represent one or more projectors that may project content directly or reflectively to the eyes of the user. For example, the display 228 may represent a transparent organic light emitting diode lens that is see through and may be utilized to display content. Projectors of the display 228 may utilize any number of wavelengths or light sources to display data, images, or other content to the user.

An LED array of the user interlace 222 may also be utilized for display actions. For example, an LED may be activated in response to someone or something being in the user's blind spot while riding a bicycle. In another embodiment, device status indications may emanate from the LED array of the wireless earpieces 202 themselves, triggered for display by the user interface 222 of the virtual reality headset 204. The battery 218 may itself be charged through a physical interface of the user interface 222. The physical interface may be integrated with the user interface 222 or may be a separate interface. For example, the user interface 222 may also include a hardware interface (e.g., port, connector, etc.) for connecting the virtual reality headset 204 to a power supply or other electronic device. The user interface 222 may be utilized for charging as well as communications with externally connected devices. For example, the user interface 222 may represent a mini-USB, micro-USB or other similar miniature standard connector. In another embodiment, a wireless inductive charging system may be utilized to initially replenish power to the wireless earpieces 202. The virtual reality headset 204 may also be charged utilizing inductive charging.

In another embodiment, the virtual reality headset. 204 may also include sensors for detecting the location, orientation, and proximity of the wireless earpieces 202. For example, the virtual reality headset 204 may include optical sensors or cameras for capturing images and other content around the periphery of the user (e.g., front, sides, behind, etc.). The virtual reality headset 204 may detect any number of wavelengths and spectra to provide distinct images, enhancement, data, and content to the user. The virtual reality headset 204 may also include an LED array, galvanic linkage or other touch sensors, battery, solar charger, actuators or vibrators, one or more touch screens or displays, an NFC chip, or other components.

As shown in FIG. 4, the sensors within one or both earpieces may include inertial sensors 240. The inertial sensors 240 are able to transmit extremely accurate data as to the precise position of the user's head relative to the virtual reality environment such as by sensing acceleration, magnetometry, and gyrometry. Especially, where both earpieces include inertial sensors 240, a user's head position within a virtual environment may be tracked. It should be understood that the audio that a user may hear within the virtual environment may be related to their head position. Thus, when the user is within the virtual environment but moves their head one way, they may hear different sounds, or head the same sounds in a different manner. Therefore, the ability to accurately determine head position allows for higher quality, more realistic user virtual reality experiences.

As originally packaged, the wireless earpieces 202 and the virtual reality headset 204 may include peripheral devices such as charging cords, power adapters, inductive charging adapters, solar cells, batteries, lanyards, additional light arrays, speakers, smart case covers, transceivers (e.g., Wi-Fi, cellular, etc.), or so forth.

FIG. 3 is a flowchart of a process for communicating with a virtual reality headset in accordance with an illustrative embodiment. In one embodiment, the process of FIG. 3 may be implemented by one or more wireless earpieces, such as the wireless earpieces 102 of FIG. 1. The method of FIG. 3 may be performed to communicate information by and between the wireless earpieces and a virtual reality headset. The wireless earpieces may synchronize playback of three dimensional sound and audio. The wireless earpieces may also synchronize the location and position of the user to display accurate virtual information, such as location, position, angle and motion of the user's head, and so forth. In addition to the virtual reality headset, the wireless earpieces may communicate with one or more electronic devices, such as a smart case, wireless devices, computing devices, entertainment devices, medical devices, or so forth, to perform the method of FIG. 3.

The process may begin with the wireless earpieces linking with a virtual reality headset (step 302). The two devices may communicate utilizing an inductive connection between the wireless earpieces and the virtual reality headset such as a magnetic induction connection such as through the use of NFMI transceivers. In another embodiment, the wireless earpieces and the virtual reality headset may utilize short range communications, such as Bluetooth, ANT+, or other radiofrequency communications to communicate.

Next, the wireless earpieces synchronize playback of audio content with visual content displayed by the virtual reality headset (step 304). The wireless earpieces may utilize any number of sensors to determine the location, velocity (e.g., linear, angular, etc.), position of the user (and the user's head), biometric condition (e.g., heart rate, blood oxygenation, temperature, etc.), and other information to adjust the exact timing, volume, tuning, balance, fade, and other audio effects communicated to the user by the speakers of the wireless earpieces. The wireless earpieces may also send or receive commands for synchronizing and managing the audio content played by the wireless earpieces with the visual content.

The information may be coordinated based on user actions, conditions, position, location, or so forth. For example, specific three dimensional noises may be played in each of the wireless earpieces corresponding to the left and right ears of the user to make the environment seem more realistic. Likewise, the volume and other audio effects may be varied to match the orientation of the user's head (or avatar) within a virtual environment. The audio content may include flags, timestamps, or other information for synchronizing playback. The synchronization of the audio and visual content may ensure that the user does not become disoriented, motion sick, or otherwise adversely affected.

Next, the wireless earpieces receive the audio content (step 306). As previously noted, the audio content may be received, from the virtual reality headset or virtual reality system. In one embodiment, the virtual reality headset is coupled to the wireless earpieces through mimetic induction to allow for communication. In yet other embodiments, short range radio signals, such as Bluetooth, ANT+, or other radiofrequency protocols, standards, or connections may be utilized

Next, the wireless earpieces play the audio content (step 308). The audio content may be played based on synchronization information determined between the virtual reality headset and the wireless earpieces. For example, the left and right wireless earpieces may play distinct content based on the virtual reality environment with which the user is interacting. As a result, distinct sounds, volumes, and audio effects may be utilized by each of the wireless earpieces. As a result, the user is able to experience a unique virtual environment with corresponding sounds without significant increases in weight or other forces imposed upon the user by much larger sound systems.

The illustrative embodiments are not to be limited to the particular embodiments described herein. In particular, the illustrative embodiments contemplate numerous variations in the type of ways in which embodiments may be applied. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention, it is understood that any other modifications, substitutions, and/or additions may be made, which are within the intended spirit and scope of the disclosure. For the foregoing, it can be seen that the disclosure accomplishes at least all of the intended objectives. The previous detailed description is of a small number of embodiments for implementing the invention and is not intended to be limiting in scope. The following claims set forth a number of the embodiments of the invention disclosed with greater particularity.

What is claimed is:

1. A method for communicating with a virtual reality headset, comprising:
linking wireless earpieces with the virtual reality headset;
synchronizing playback of audio content with visual content displayed by the virtual reality headset; and
playing the audio content in response to receiving the audio content from the virtual reality headset.

2. The method of claim 1, wherein the wireless earpieces are coupled to the virtual reality headset through magnetic induction.

3. The method of claim 1, further comprising:
performing sensor measurements from the wireless earpieces; and
communicating the sensor measurements from the wireless earpieces to the virtual reality headset.

4. The method of claim 1, further comprising sensing inertial data at one or more of the wireless earpieces to determine an orientation ardor position of the head of a user utilizing the virtual reality headset and the wireless earpieces.

5. The method of claim 4, wherein the audio content is played in response to the orientation and/or position of the head of the user.

6. The method of claim 1, further comprising:
receiving additional sensor measurements from the virtual reality headset; and
playing the audio content in response to the additional sensor measurements.

7. The method of claim 1, further comprising:
performing biometric, analysis of a user utilizing one or more biometric sensors of the wireless earpieces, wherein the playing is performed in response to the biometric analysis.

8. The method of claim 1, wherein the one or more biometric sensors include at least one of a pulse oximeter and a temperature sensor.

9. A set of wireless earpieces, comprising:
a left earpiece and a right ear piece, each of the left earpiece and the right earpiece comprising an ear piece housing, a processor disposed within the earpiece housing for executing a set of instructions; and
a memory for storing the set of instructions, wherein the set of instructions are executed to:
link the wireless earpieces with the virtual reality headset;
link the left earpiece and the right earpiece;
synchronize playback of audio content with visual con tent displayed by the virtual reality headset; and
play the audio content in response to receiving the audio content from the virtual reality headset.

10. The wireless earpieces of claim 11, wherein the wireless earpieces are in operative communication with the virtual reality headset through magnetic induction.

11. The wireless earpieces of claim 11, wherein the set of instructions are further executed to:
perform sensor measurements from sensors of the wireless earpieces; and
communicate the sensor measurements from the wireless earpieces to the virtual reality headset.

12. The wireless earpieces of claim 13, wherein the sensors include at least gyroscopes and accelerometers for determining an orientation and position of the head of a user utilizing the virtual reality headset and a pulse oximeter and thermometer.

13. A virtual reality system, comprising:
a virtual reality headset for displaying a virtual reality environment to a user;
wireless earpieces playing audio content associated with the virtual reality environment to the user, wherein the wireless earpieces are coupled to the virtual reality headset by connectors through magnetic induction.

14. The virtual reality system of claim 15, wherein the wireless earpieces include at least one inertial sensor for determining an orientation and/or position of the head of a user utilizing the virtual reality headset and at least one biometric sensor.

15. The virtual reality system of claim 16 wherein the at least one biometric sensor comprises at least one of a pulse oximeter and a temperature sensor.

16. The virtual reality system of claim 16, wherein the wireless earpieces perform biometric analysis of the user utilizing one or more biometric sensors of the wireless earpieces, wherein the playing is performed in response to the biometric analysis.
